(19) United States
(12) Patent Application Publication
(10) Pub. No.: US 2009/0056435 A1
(43) Pub. Date: Mar. 5, 2009

(54) Product array and method of merchandising tissue products

(76) Inventors: Dean Larry DuVal, Lebanon, OH (US); Kevin Mitchell Wiwi, West Chester, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/899,228

(22) Filed: Sep. 5, 2007

(51) Int. Cl. G01L 5/04

(52) U.S. Cl. 73/159

(57) ABSTRACT

An array of tissue products having: a. a first group comprising two or more tissue products, from at least two different product manufacturers, each product having an indicium representing an intensive property for softness; b. a second group comprising two or more tissue products, from at least two different product manufacturers, each product having an indicium representing the intensive property for strength or absorbency; and c. a third group of tissue products comprising two or more tissue products, from at least two different product manufacturers, each product having a lower price, to the consumer, per package of equivalent roll count than each product of the first group and the second group, of tissue products; wherein the Softness PSU of each product of the first group is greater than the Softness PSU of each product of the second group and each product of the third group; and the HFS value of each product of the second group is greater than about 65 g/sheet.

### FIELD OF THE INVENTION

The present invention relates to an array of tissue products, and a method for merchandising tissue products to provide consumers with their desired tissue product.

### BACKGROUND OF THE INVENTION

Paper products, used for paper towels, toilet tissue, facial tissue, napkins, and the like, are staples of everyday life. Consumers differ in their preferences for the attributes associated with these products. For example, some consumers desire a very strong product for maximum cleaning performance and absorption of liquid spills. These consumers may desire a product that will not shred and may be reused, for a variety of scrubbing and cleaning jobs around the kitchen. Other consumers may desire a paper towel product that provides some sensory benefit, e.g. softness, cloth-like feel, pleasant scent, soft enough for cleaning children's faces, as well as strong enough to function as a cleaning wipe. Others may even prefer a paper towel that represents a good value, offers the right amount of performance achievable, with less waste, at a more moderate price.

Consumers may face an overwhelming number of product options when shopping for a specific tissue product. A large number of products variations is offered such as roll sizes, number of plies, scents, colors, graphics, functional benefits, etc. In addition, manufacturers of tissue products typically include claims on their products to provide consumer information as well as to distinguish their products from competing products. Consumers, therefore, must also interpret a significant amount of textual and graphic information associated with these products.

In addition mass retailers usually shelve the same type of products, made by different manufactures, together on the shelf. In this regard, the goal of the retailer is to provide a large number of such products to be viewed quickly, permitting the consumer to compare the products for quality and value, and to easily find all offerings of specific product types in one place in the store. The length of time required, however, for consumers to select their desired product from this arrangement, is considerable and unworkable for many consumers.

Furthermore, it is believed that the longer it takes for a consumer to identify a desired product on the store shelf, the less likely they will select this product for purchase while in the store. This poses disadvantages for both the retailer and the manufacturer. This delay time in identifying the appropriate product on the store shelf can affect both initial purchase as well as the repurchase of that product. When it is difficult for the consumer to find the desired product in the retail store, the repurchase intent is also impacted, even if the consumer has used and liked the performance of a product in the past.

Accordingly, there is a need for an array of tissue products, associated with providing the consumer with a desired product having product benefits that are readily and easily identified by the consumer.

Therefore, an array of tissue products is provided, as well as a method of merchandising, wherein the array and method offer consumers a greater ease and opportunity to quickly identify and select the desired tissue product.

### SUMMARY OF THE INVENTION

In one embodiment, this invention relates to an array of tissue products comprising: a. a first group comprising two or more tissue products, from at least two different product manufacturers, each product having an indicium representing an intensive property for softness; b. a second group comprising two or more tissue products, from at least two different product manufacturers, each product having an indicium representing the intensive property for strength or absorbency; and c. a third group of tissue products comprising two or more tissue products, from at least two different product manufacturers, each product having a lower price, to the consumer, per package of equivalent roll count than each product of the first group and the second group, of tissue products; wherein the Softness PSU of each product of the first group is greater than the Softness PSU of each product of the second group and each product of the third group; and the HFS value of each product of the second group is greater than about 65 g/sheet.

The invention further relates to a method of merchandising tissue products for display or sale in a retail environment comprising: providing an array of tissue products comprising the above array, and arranging the first group, second group, and third group of tissue products in visual proximity to each other in the retail store.

### BRIEF DESCRIPTION OF THE DRAWINGS

FIG. 1 is a schematic illustration of an array of tissue products, with a section of the products cut away to show the product therein, according to the present invention.

### DETAILED DESCRIPTION OF THE INVENTION

### Definitions

“Sanitary tissue product” or “tissue product” as used herein means a wiping implement for post-urinary and/or post-bowel movement cleaning (toilet tissue products), for otorhinolaryngological discharges (facial tissue products) and/or multi-functional absorbent and cleaning uses (absorbent towels such as paper towel products and/or wipe products). The sanitary tissue products of the present invention may comprise one or more fibrous structures and/or finished fibrous structures, traditionally, but not necessarily, comprising cellulose fibers. In one embodiment, the tissue products of the present invention include tissue-towel paper products.

A “tissue-towel paper product” refers to products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include toweling, facial tissue, bath tissue, table napkins, and the like.

“Ply” or “Plies”, as used herein, means an individual fibrous structure or sheet of fibrous structure, optionally to be disposed in a substantially contiguous, face-to-face relationship with other plies, forming a multi-ply fibrous structure. It is also contemplated that a single fibrous structure can effectively form two “plies” or multiple “plies”, for example, by being folded on itself. In one embodiment, the ply has an end use as a tissue-towel paper product. A ply may comprise one or more wet-laid layers, air-laid layers, and/or combinations thereof. If more than one layer is used, it is not necessary for each layer to be made from the same fibrous structure. Further, the layers may or may not be homogenous within a layer. The actual makeup of a tissue paper ply is generally determined by the desired benefits of the final tissue-towel paper product, as would be known to one of skill in the art. The fibrous structure may comprise one or more plies of non-woven materials in addition to the wet-laid and/or air-laid plies.

The term “fibrous structure”, as used herein, means an arrangement of fibers produced in any papermaking machine known in the art to create a ply of paper. “Fiber” means an elongate particulate having an apparent length greatly exceeding its apparent width. More specifically, and as used herein, fiber refers to such fibers suitable for a papermaking process.

“Basis Weight”, as used herein, is the weight per unit area of a sample reported in lbs/3000 ft² or g/m².

“Machine Direction” or “MD”, as used herein, means the direction parallel to the flow of the fibrous structure through the papermaking machine and/or product manufacturing equipment.

“Cross Machine Direction” or “CD”, as used herein, means the direction perpendicular to the machine direction in the same plane of the fibrous structure and/or fibrous structure product comprising the fibrous structure.

“Densified”, as used herein, means that portion of a fibrous structure product that exhibits a greater density than another portion of the fibrous structure product.

“Non-densified”, as used herein, means a portion of a fibrous structure product that exhibits a lesser density than another portion of the fibrous structure product.

“Array of tissue products” as used herein means a group of tissue products within a category such as paper towels, toilet tissue, facial tissue, wipes. In one embodiment, such a group of sanitary tissue products includes those tissue products that reside on the same shelf in a retail store and/or in the same aisle in a retail store. For example, toilet tissue products are an array of tissue products, as are paper towel products.

“Group” as used herein means a group of tissue products that is a subset of the total shelf set or display of tissue products and that may contain only products having a common intensive property of similar values.

“Visual proximity” refers to regions or items in a retail store that may all be viewed by a consumer standing in one location.

“Spatially separated” refers to regions or items in a retail store that are not in proximity to one another, such as might require a consumer to travel to a remote or different region of the store, or to exit one region such as an aisle, to reach the other region or item; adjoining regions of the store, such as on either side (i.e., facing sides) of an aisle, are not considered to be spatially separated; however, consecutive aisles would generally be considered to be spatially separated. Regions or items in a retail store that are spatially separated are not generally in visual proximity to one another.

“Retail Store” refers to a business that offers durable and/or disposable products such as tissue products for sale, and includes large food, drug, club, grocery stores, etc.

“Intensive property” as used herein means a property of a fibrous structure and/or sanitary tissue product, that is selected from the group consisting of: lint, softness, basis weight, texture, PSU,. tensile strength, especially total dry tensile strength, absorbency, and mixtures thereof.

“Common intensive property” as used herein means an intensive property that is present in two or more fibrous structures and/or sanitary tissue products.

“Dominant common intensive property” as used herein means the greatest of two or more values of a common intensive property. For example, if a first sanitary tissue product exhibits a total dry tensile strength of about 650 g/in and another sanitary tissue product exhibits a total dry tensile strength of about 500 g/in, then the dominant common intensive property is the 650 g/in and the sanitary tissue product that exhibits a total dry tensile strength of about 650 g/in exhibits the dominant common intensive property for strength. In other words, one of the sanitary tissue products exhibits greater total dry tensile strength than the other sanitary tissue product. In another example, if a first sanitary tissue product exhibits a softness, represented by a Softness PSU of about 0.3 PSU to about 4 PSU, greater than the Softness PSU of another tissue product, then the first product exhibits the dominant common intensive property for softness. In other words, one of the first sanitary tissue product is softer than the other sanitary tissue product. Relative values between sanitary tissue products, such as one sanitary tissue product is softer than another sanitary tissue product may be used to identify the dominant common intensive property in addition to the absolute values of common intensive properties.

In one example, in order for a common intensive property for strength of one sanitary tissue product to be a dominant common intensive property compared to another sanitary tissue product, the relative difference in the values of the common intensive properties for strength of the sanitary tissue products has to be greater than about 5% and/or greater than about 10% and/or greater than about 15% and/or greater than about 20% and/or greater than about 25% and/or greater than about 30% and/or greater than about 50%. In another embodiment the relative differences in the values of the common intensive properties of the tissue products is from about 5% to about 50%, and/or about 10% to about 45%, and/or about 20% to about 40%.

“Indicium” and/or “indicia” as used herein means an identifier and/or indicator and/or suggestion, of the products property, such as an intensive property of a sanitary tissue product.

“Textual indicium” and/or “textual indicia” as used herein means a text indicium, lo such as a word and/or phrase that communicates to a consumer a property about the sanitary tissue product it is associated with. In one example, a sanitary tissue product, such as a toilet or paper towel tissue product, is housed in a package comprising a textual indicium; namely, the word “Strong” or the word “Soft.” Nonlimiting examples of textual indicia include text, such as brand names, which may be the same, separate, Is independent product designations that reinforce and/or support non-textual indicia present on the packages.

“Non-textual indicium” and/or non-textual indicia” as used herein means a non-text indicium that communicates to a consumer through a consumer's senses. In one example, a non-textual indicium may communicate, even intuitively communicate, to a consumer through sight (visual indicium), through touch (texture indicium) and/or through sound (sound indicium) and/or through smell (scent indicium). For example non-textual indicia may include emboss patterns, etc.

Nonlimiting examples of non-textual indicia include colors, textures, patterns, such as emboss patterns and/or emboss pattern images, character representations, action representations, and mixture thereof.

“Dominant indicium” and/or “dominant indicia” as used herein means that a package and/or sanitary tissue product, itself, comprises only an indicium that communicates a single intensive property of a sanitary tissue product or that a package and/or sanitary tissue product, itself, comprises an indicium that communicates more than one intensive property of a sanitary tissue product wherein a consumer interprets the totality of the indicium as indicating that the sanitary tissue product exhibits a dominant intensive property. For example, a package may comprise only an indicium that communicates the intensive property of strength, such as total dry tensile strength, to a consumer so that strength would be the dominant indicium. In another example, a package may comprise the phrase “soft and strong” all in the same font and same color—there would be no dominant indicium based on this phrase. However, if the phrase was “soft and STRONG” where the word strong was somehow emphasized to stand out so that a consumer would interpret the dominant intensive property of the sanitary tissue product to be strength, such as total dry tensile strength, then strength or strong would be the dominant indicium.

“Dry Tensile Strength” (or simply “Tensile Strength” as used herein) of a fibrous structure of the present invention and/or a sanitary tissue product comprising such fibrous structure is measured according to the Tensile Strength Test Method described herein.

“Softness” as used herein means the softness of a fibrous structure according to the present invention and/or a sanitary tissue product comprising such fibrous structure, which is determined according to the Softness Test Method herein.

### Tissue Products

In one embodiment, the fibrous structure or tissue product has a basis weight of from about 20 lbs/3000 ft² to about 50 lbs/3000 ft². In another embodiment the basis weight is about 22 lbs/3000 ft² to about 40 lbs/3000 ft²; and in yet another embodiment the basis weight is about 25 lbs/3000 ft² and about 38 lbs/3000 ft².

The sanitary tissue products of the present invention may exhibit a basis weight between about 10, 15, 20, 30, 40, 50 (g/m²) to about 90, 100, 110, 120 (g/m²) and combinations of these to form ranges. In addition, the sanitary tissue product of the present invention may exhibit a basis weight between about 55 g/m₂ to about 105 g/m² and/or from about 60 to 100 g/m².

The sanitary tissue products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in).

In one embodiment, the Softness PSU of each of the products in the first group is from about 0.5 PSU to about 4 PSU, in-another embodiment from about 1 PSU to about 3 PSU and/or from about 1.5 PSU to about 2.5 PSU, greater than the Softness PSU of each product in the second group and/or each product in the third group.

In one embodiment, the HFS value of each product of the second group is greater than the HFS value of each product of the first group and the third group. In another embodiment the HFS of each product of the second group is greater than about 65 g/sheet, in another embodiment is from about 65 g/sheet to about 80 g/sheet and/or from about 66 g/sheet to about 90 g/sheet. In another embodiment the HFS value of each product of the second group is about 10% to about 45% greater than the HFS value of each product of the first group and the third group.

The sanitary tissue products of the present invention may be in any suitable form, such as in a roll, in individual sheets, in connected, but perforated sheets, in a folded format or even in an unfolded.

### Array of Tissue Products

An array of tissue products according to the present invention may comprise three or more groups of tissue products. In one embodiment, the groups are arranged in a way to organize products according to their dominant marketing and advertising positioning. In this way, consumers are better able to compare products that have the same or similar features or performance characteristics, and hence, desired product selection by the consumer is enhanced. Consumers are better able to obtain the product that they prefer or desire, and may be able to make desired product selections more efficiently.

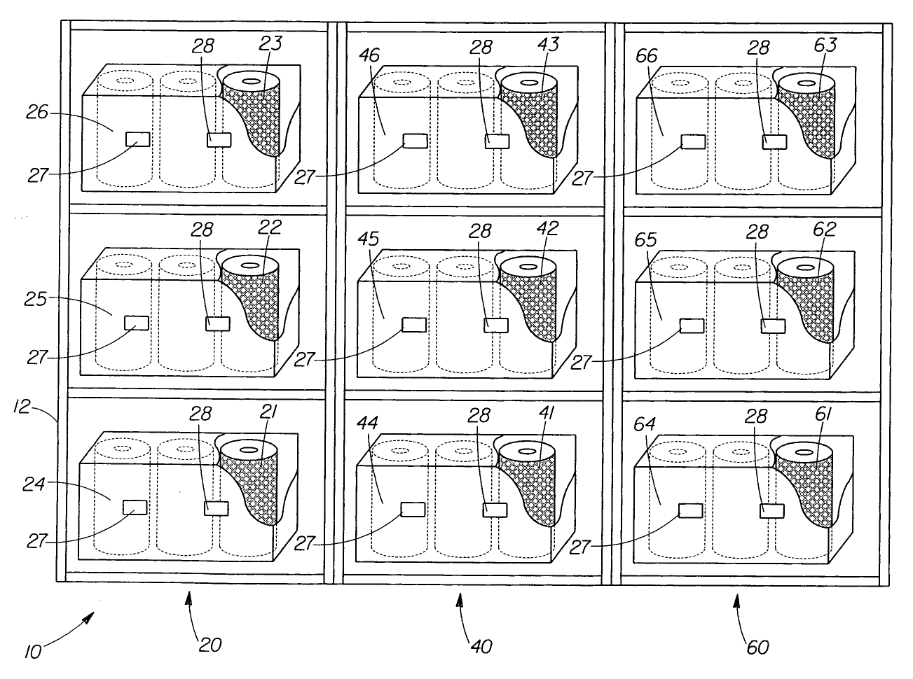

As shown in FIG. 1, in one embodiment, an array of tissue products 10 (displayed on a store shelf 12 for example) comprises a first group 20, a second group 40 and a third group 60, of tissue products. In FIG. 1 the first group 20 of tissue products has 3 different products, namely first product 21, second product 22, and third product 23. The first product 21 has a first package 24, the second product 22 has a second package 25, and the third product 23 has a third package 26.

In FIG. 1 the second group 40 of tissue products has 3 different products, namely fourth product 41, fifth product 42, and sixth product 43, packaged within the forth package 45, fifth package 45 and sixth package 46, respectively. The third group 60 also has three different tissue products, the seventh product 61 in the seventh package 64, the eight product 62 in the eight package 65 and the ninth product 63 in the ninth package 66.

In an example, all of the packages comprise an outward facing surface that is visible to the consumer at the point of sale in the retail store, and in one embodiment, the all of the packages each comprise a source identifier 27.

The first through ninth packages may comprise a source identifier 27, for example a brand name, a trademark. At least two products within the first group comprise different source identifiers and are sourced from different product manufacturers; at least two products within the second group comprise different source identifiers and are sourced from different product manufacturers and at least two products within the third group comprise different source identifiers and are sourced from different product manufacturers. The source identifier 27 may be positioned anywhere on the packages.

The first package 24, second package 25 and third package 26, may comprise an indicium 28 representing the intensive property of softness. The fourth package 44, fifth package 45 and sixth package 46 may comprises an indicium 28 representing the intensive property of strength. The third group 60 comprising a seventh package 64, eighth package 65 and ninth package 66, which may or may not comprise an indicium 28 representing an intensive property, in one embodiment having an indicium other than softness or strength.

In one embodiment the indicium 28 of the fourth package 44, the fifth package 45 and the sixth package 46, is a dominant strength indicium, for example wording in larger font describing the intensive property of strength.

In one embodiment the indicium 28 of the first package 24, second package 25 and third package 26, may comprise a dominant softness indicium, for example wording in larger font describing the intensive property of softness.

In one embodiment, the seventh product 61, the eight product 62, and the ninth product 63 may comprise an indicium for an intensive property, other than softness or strength, or exhibit a value of an intensive property that is the same and/or different from the value of the intensive property for the products in the first group 20 or the second group 40. The indicium of the seventh product 61, the eight product 62, and the ninth product 63, may be matched to an intensive property of that product. In one embodiment, none of the packages in the second group 40 and the third group 60 have an indicium representing the intensive property for softness.

In another example, any of the packages of the first, second, third groups, 20, 40, and 60, respectively, may comprise information about various roll sizes of the tissue products.

In FIG. 1 the products in the first group 20, second group 40 and the third group 60, are horizontally arranged relative to each other. In one embodiment the products in the first group 20, second group 40 and the third group 60, may be either vertical or horizontally arranged relative to each other. The first group 20, second group 40 and the third group 60 may be organized such that one group is on each shelf, for example, the first group may be on the top shelf, the second group may be on the middle shelf and the third group may be on the bottom shelf.

In one embodiment, each product in the first group 20 of tissue products comprises a Softness PSU that is equal to and/or greater than the Softness PSU of the products of the second group 40 and/or products of the third group 60. In one embodiment, each tissue product of the second group 40 of tissue products comprises a total dry tensile strength that is greater than the total dry tensile strength of the products of the third group 60 of sanitary tissue products. In another embodiment, the third group 60 of tissue products has a lower price, to the consumer, per package of equivalent roll count than the first group 20 and second group 40 of tissue products. At least two tissue products in the first group 20 are sourced from different product manufacturers. At least two tissue products in the second group 40 are sourced from different product manufacturers. At least two tissue products in the third group 60 are sourced from different product manufacturers.

In another embodiment each of the products of the first group 20 of tissue products exhibits a Softness PSU of about 0.3 PSU to about 4 PSU and/or a Softness PSU of about 1 PSU to about 3 PSU, relative to each product of the second group 40 and/or each product of the third group 60.

In another embodiment, the second group 40 of tissue products exhibits a total dry tensile strength that is 10%, 15%, and/or 20%, greater than the total dry tensile strength of each product of the third group 60 of tissue products. In another embodiment the second group 40 of tissue products exhibits a total dry tensile strength that is about 10% to about 45% greater than the dry tensile strength of each of the products of the third group 60 of sanitary tissue products. In one embodiment, the second group 40 of tissue products exhibits a total dry tensile strength from about 550 g/in to about 3,000 g/in tensile, and/or from about 800 g/in to about 2,400 g/in tensile, and/or from about 1000 g/in to about 2,000 g/in tensile.

In one embodiment, the second group 40 of tissue products exhibits a total dry tensile strength that is about 10% to about 45% greater than the first group 20 and/or the third group 60 of sanitary tissue products and/or wherein the second group 40 of tissue products exhibits a total dry tensile strength that is about 20% to about 40% greater than the tensile strength of the first group 20 and/or the third group 60 of tissue products.

In one embodiment, all of the products in the second group 40 have a dominant common intensive property for strength relative to the products in the first group 20 and the third group 60.

The packages may be made from any suitable packaging material known in the art. Nonlimiting examples include polywrap, polymer films, such as polyolefin films, polyester films, paper, cardboard, plastic, wood, metal and other suitable packaging materials. In one example, one or more of the packages comprise the same material, in another embodiment, comprises a polyolefin film, polyester film, and mixtures thereof, in still another embodiment, one or more of the packages comprises cardboard.

In FIG. 1 each group of products may have the same roll-count packaging. The products within each group of tissue products may or may not comprise packages that have the same number of rolls, same number of sheets or the same number of rolls offered in a multiple roll count packages. In one example, an array of tissue products in accordance with the present invention may comprise a plurality (two or more) of single-and/or multi-ply (e.g. two ply) sanitary tissue products. The array may comprise at least one single-ply sanitary tissue product. The array may comprise a mixture of single-ply and multi-ply sanitary tissue products. The sanitary tissue products may be dry and/or wet. The sanitary tissue products may come in a variety of roll sizes and may be packaged in different numbers of rolls, such as four, six, nine, twenty-four, and the like. The array of sanitary tissue packages may be displayed on a shelf, pallet, etc., at a point of sale, such as within a retail store, in such as way that the different sanitary tissue products within the array are visible to a consumer during the consumer's purchasing decision process.

Two or more sanitary tissue products within an array of sanitary tissue products may differ in price; for example, differ in retail price per package of equivalent roll count to a consumer. In one embodiment, the products in the third group 60 comprises a lower price per package of equivalent roll count relative to the products in the first group and second groups.

### Single or Multi-ply Fibrous Structure or Tissue Product

The tissue products in the array herein may include paper towels, toilet tissue, facial tissue, napkins, and the like.

In one embodiment the fibrous structure or tissue product herein comprises from about 16% to about 40%, or about 23% to about 40% of hardwood fibers, in another embodiment from about 18% to about 35%, in yet another embodiment from about 25% to about 33%, of hardwood fibers, by weight of the fibrous structure or tissue product. In one embodiment the hardwood fiber are eucalyptus fibers.

In one embodiment the fibrous structure or tissue products comprise pulps derived from deciduous hardwood trees, and may be selected from the group consisting of Acacia, Eucalyptus, Maple, Oak, Aspen, Birch, Cottonwood, Alder, Ash, Cherry, Elm, Hickory, Poplar, Gum, Walnut, Locust, Sycamore, Beech, Catalpa, Sassafras, Gmelina, Albizia, Anthocephalus, Magnolia, Bagasse, Bass, Kenaf, and combinations thereof. In another embodiment the hardwood fiber is selected from the group consisting of Eucalyptus, Aspen, Birch, Beech, Oak, Maple, Gum and combinations thereof; in another embodiment Eucalyptus.

In one embodiment the present invention contemplates the use of a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps, as well as mechanical pulps including, groundwood, thermomechanical pulp, chemically modified, and the like. Chemical pulps may be used in tissue towel embodiments since they are known to those of skill in the art to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from pulp such as cotton linters, bagesse, and the like, can be used. Additionally, fibers derived from recycled paper, which may contain any of all of the categories as well as other non-fibrous materials such as fillers and adhesives used to manufacture the original paper product may be used in the present web. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, polyethylene, and polypropylene fibers can be used within the scope of the present invention. Further, such fibers may be latex bonded.

In one embodiment the paper is produced by forming a predominantly aqueous slurry comprising about 95% to about 99.9% water.

In one embodiment the non-aqueous component of the slurry, used to make the fibrous structure, comprises only eucalyptus and NSK. The aqueous slurry is to be pumped to the headbox of the papermaking process.

In addition to the limitations disclosed herein, the fibrous structure product may comprise any tissue-towel paper product known in the industry. Embodiment of these substrates may be made according U.S. Pat. No. 4,191,609 issued Mar. 4, 1980 to Trokhan; U.S. Pat. No. 4,300,981 issued to Carstens on Nov. 17, 1981; U.S. Pat. No. 4,191,609 issued to Trokhan on Mar. 4, 1980; U.S. Pat. No. 4,514,345 issued to Johnson et al. on Apr. 30, 1985; U.S. Pat. No. 4,528,239 issued to Trokhan on Jul. 9, 1985; U.S. Pat. No. 4,529,480 issued to Trokhan on Jul. 16, 1985; U.S. Pat. No. 4,637,859 issued to Trokhan on Jan. 20, 1987; U.S. Pat. No. 5,245,025 issued to Trokhan et al. on Sep. 14, 1993; U.S. Pat. No. 5,275,700 issued to Trokhan on Jan. 4, 1994; U.S. Pat. No. 5,328,565 issued to Rasch et al. on Jul. 12, 1994; U.S. Pat. No. 5,334,289 issued to Trokhan et al. on Aug. 2, 1994; U.S. Pat. No. 5,364,504 issued to Smurkowski et al. on Nov. 15, 1995; U.S. Pat. No. 5,527,428 issued to Trokhan et al. on Jun. 18, 1996; U.S. Pat. No. 5,556,509 issued to Trokhan et al. on Sep. 17, 1996; U.S. Pat. No. 5,628,876 issued to Ayers et al. on May 13, 1997; U.S. Pat. No. 5,629,052 issued to Trokhan et al. on May 13, 1997; U.S. Pat. No. 5,637,194 issued to Ampulski et al. on Jun. 10, 1997; U.S. Pat. No. 5,411,636 issued to Hermans et al. on May 2, 1995; EP 677612 published in the name of Wendt et al. on Oct. 18, 1995, and U.S. Patent Application 2004/0192136A1 published in the name of Gusky et al. on Sep. 30, 2004.

The tissue-towel substrates may be manufactured via a wet-laid making process where the resulting web is through-air-dried or conventionally dried. Optionally, the substrate may be foreshortened by creping or by wet microcontraction. Creping and/or wet microcontraction are disclosed in commonly assigned U.S. Pat. No. 6,048,938 issued to Neal et al. on Apr. 11, 2000; U.S. Pat. No. 5,942,085 issued to Neal et al. on Aug. 24, 1999; U.S. Pat. No. 5,865,950 issued to Vinson et al. on Feb. 2, 1999; U.S. Pat. No. 4,440,597 issued to Wells et al. on Apr. 3, 1984; U.S. Pat. No. 4,191,756 issued to Sawdai on May 4, 1980; and U.S. Pat. No. 6,187,138 issued to Neal et al. on Feb. 13, 2001.

Conventionally pressed tissue paper and methods for making such paper are known in the art, for example U.S. Pat. No. 6,547,928 issued to Barnholtz et al. on Apr. 15, 2003. Another suitable tissue paper is pattern densified tissue paper which is characterized by having a relatively high-bulk field of relatively low structure density, (which may be discrete and/or fully or partially interconnected) and an array of densified zones of relatively high structure density. The high-bulk field is alternatively characterized as a field of pillow regions. The densified zones are alternatively referred to as knuckle regions. The densified zones may be discretely spaced within the high-bulk field or may be interconnected, either fully or partially, within the high-bulk field.

Processes for making pattern densified tissue webs are disclosed in U.S. Pat. No. 3,301,746, issued to Sanford, et al. on Jan. 31, 1967; U.S. Pat. No. 3,974,025, issued to Ayers on Aug. 10, 1976; U.S. Pat. No. 4,191,609, issued to on Mar. 4, 1980; and U.S. Pat. No. 4,637,859, issued to on Jan. 20, 1987; U.S. Pat. No. 3,301,746, issued to Sanford, et al. on Jan. 31, 1967; U.S. Pat. No. 3,821,068, issued to Salvucci, Jr. et al. on May 21, 1974; U.S. Pat. No. 3,974,025, issued to Ayers on Aug. 10, 1976; U.S. Pat. No. 3,573,164, issued to Friedberg, et al. on Mar. 30, 1971; U.S. Pat. No. 3,473,576, issued to Amneus on Oct. 21, 1969; U.S. Pat. No. 4,239,065, issued to Trokhan on Dec. 16, 1980; and U.S. Pat. No. 4,528,239, issued to Trokhan on Jul. 9, 1985.

Uncompacted, non pattern-densified tissue paper structures are also contemplated within the scope of the present invention and are described in U.S. Pat. No. 3,812,000 issued to Joseph L. Salvucci, Jr. et al. on May 21, 1974; and U.S. Pat. No. 4,208,459, issued to Henry E. Becker, et al. on Jun. 17, 1980. Uncreped tissue paper as defined in the art is also contemplated. The techniques to produce uncreped tissue in this manner are taught in the prior art; for example, Wendt, et al. in European Patent Application 0 677 612A2, published Oct. 18, 1995; Hyland, et al. in European Patent Application 0 617 164A1, published Sep. 28, 1994; and Farrington, et al. in U.S. Pat. No. 5,656,132 issued Aug. 12, 1997.

Uncreped tissue paper, in one embodiment, refers to tissue paper which is non-compressively dried, in one embodiment, by through air drying. The techniques to produce uncreped tissue in this manner are taught in the prior art; for example, Wendt, et al. in European Patent Application 0 677 612A2, published Oct. 18, 1995; Hyland, et al. in European Patent Application 0 617 164 A1, published Sep. 28, 1994; and Farrington, et al. in U.S. Pat. No. 5,656,132 published Aug. 12, 1997.

Other materials are also intended to be within the scope of the present invention as long as they do not interfere or counteract any advantage presented by the instant invention.

The substrate which comprises the fibrous structure of the present invention may be cellulosic, or a combination of both cellulose and non-cellulose. The substrate may be conventionally dried using one or more press felts or through-air dried. If the substrate which comprises the paper according to the present invention is conventionally dried, it may be conventionally dried using a felt which applies a pattern to the paper as taught by commonly assigned U.S. Pat. No. 5,556,509 issued Sep. 17, 1996 to Trokhan et al. and PCT Application WO 96/00812 published Jan. 11, 1996 in the name of Trokhan et al. The substrate which comprises the paper according to the present invention may also be through air dried. A suitable through air dried substrate may be made according to commonly assigned U.S. Pat. Nos. 4,191,609; 4,239,065, issued Dec. 16, 1980, Trokhan and U.S. Pat. No. 3,905,863, issued Sept. 16, 1075, Ayres.

The fibrous structure product according to the present invention may be made according to commonly assigned U.S. Pat. No. 4,528,239 issued Jul. 9, 1985 to Trokhan; U.S. Pat. No. 4,529,480 issued Jul. 16, 1985 to Trokhan; U.S. Pat. No. 5,275,700 issued Jan. 4, 1994 to Trokhan; U.S. Pat. No. 5,364,504 issued Nov. 15, 1985 to Smurkoski et al.; U.S. Pat. No. 5,527,428 issued Jun. 18, 1996 to Trokhan et al.; U.S. Pat. No. 5,609,725 issued Mar. 11, 1997 to Van Phan; U.S. Pat. No. 5,679,222 issued Oct. 21, 1997 to Rasch et al.; U.S. Pat. No. 5,709,775 issued Jan. 20, 1995 to Trokhan et al.; U.S. Pat. No. 5,795,440 issued Aug. 18, 1998 to Ampulski et al.; U.S. Pat. No. 5,900,122 issued May 4, 1999 to Huston; U.S. Pat. No. 5,906,710 issued May 25, 1999 to Trokhan; U.S. Pat. No. 5,935,381 issued Aug. 10, 1999 to Trokhan et al.; and U.S. Pat. No. 5,938,893 issued Aug. 17, 1999 to Trokhan et al.

In one embodiment, the tissue product is multi ply, and the plies of the multi-ply fibrous structure may be the same substrate respectively or the plies may comprise different substrates combined to create desired consumer benefits. In one embodiment, the fibrous structures comprise two plies of tissue substrate. In another embodiment, the fibrous structure comprises a first ply, a second ply, and at least one inner ply.

In one embodiment, of the present invention, the fibrous structure product has a plurality of embossments. In one embodiment, the embossment pattern is applied only to one ply. In another embodiment the fibrous structure product is a two ply product wherein both plies comprise a plurality of embossments. In one embodiment the fibrous structure product comprises two or more plies of fibrous structure wherein at least one of the piles has a plurality of embossments thereon.

Suitable means of embossing include those disclosed in U.S. Pat. No. 3,323,983 issued to Palmer on Sept. 8, 1964; U.S. Pat. No. 5,468,323 issued to McNeil on Nov. 21, 1995; U.S. Pat. No. 5,693,406 issued to Wegele et al. on Dec. 2, 1997; U.S. Pat. No. 5,972,466 issued to Trokhan on Oct. 26, 1999; U.S. Pat. No. 6,030,690 issued to McNeil et al. on Feb. 29, 2000; and U.S. Pat. No. 6,086,715 issued to McNeil on July 11.

Suitable means of laminating the plies include but are not limited to those methods disclosed in commonly assigned U.S. Pat. Nos. 6,113,723 issued to McNeil et al. on Sep. 5, 2000; U.S. Pat. No. 6,086,715 issued to McNeil on Jul. 11, 2000; U.S. Pat. No. 5,972,466 issued to Trokhan on Oct. 26, 1999; U.S. Pat. No. 5,858,554 issued to Neal et al. on Jan. 12, 1999; U.S. Pat. No. 5,693,406 issued to Wegele et al. on Dec. 2, 1997; U.S. Pat. No. 5,468,323 issued to McNeil on Nov. 21, 1995; U.S. Pat. No. 5,294,475 issued to McNeil on Mar. 15, 1994.

The multi-ply fibrous structure product may be in roll form. When in roll form, the multi-ply fibrous structure product may be wound about a core or may be wound without a core.

### Optional Ingredients

The fibrous structure product herein may optionally, in one embodiment, comprise one or more ingredients that may be added to the aqueous papermaking furnish or the embryonic web. These optional ingredients may be added to impart other desirable characteristics to the product or improve the papermaking process so long as they are compatible with the other components of the fibrous structure product and do not significantly and adversely affect the functional qualities of the present invention. In one embodiment the optional chemical ingredients include cationic charge biasing species; high surface area, high anionic charge microparticles for the purposes of improving formation, drainage, strength, and retention may also be included herein. See, for example, U.S. Pat. No. 5,221,435, issued to Smith on Jun. 22, 1993. Other optional ingredients include cationic wet strength resins at a level of from about 2 to about 50 lbs./ton of dry paper fibers of the cationic wet strength resin, in another embodiment from about 5 to about 30 lbs./ton. If enhanced absorbency is needed, surfactants may be used to treat the tissue product of the present invention, in one embodiment, from about 0.01% to about 2.0% by weight, based on the dry fiber weight of the tissue web. Chemical softening agents, organo-reactive polydimethyl siloxane ingredients, including the amino functional polydimethyl siloxane, diorganopolysiloxane-based polymers, silicone gums, fluid diorganopolysiloxane polymers, etc., and mixtures thereof, may be optionally included in the tissue products herein.

The chemical softening agents are generally useful at a level of from about 0.01% to about 15%, in another embodiment from about 0.1% to about 3%, and in another embodiment from about 0.2% to about 2% by weight of the fibrous structure product.

Filler materials may also be incorporated into the fibrous substrate products of the present invention. U.S. Pat. No. 5,611,890, issued to Vinson et al. on Mar. 18, 1997, discloses filled tissue-towel paper products that are acceptable as substrates for the present invention.

### Test Methods

Unless otherwise indicated, all tests described herein including those described under the Definitions section and the following test methods are conducted on samples, fibrous structure samples and/or sanitary tissue product samples and/or handsheets that have been conditioned in a conditioned room at a temperature of 73° F.±4° F. (about 23° C.±2.2° C.) and a relative humidity of 50%±10% for 2 hours prior to the test. Further, all tests are conducted in such conditioned room.

### Softness Test Method (PSU):

Ideally, prior to softness testing, the samples to be tested should be conditioned according to Tappi Method #T4020M-88. Here, samples are preconditioned for 24 hours at a relative humidity level of 10 to 35% and within a temperature range of 22° C. to 40° C. After this preconditioning step, samples should be conditioned for 24 hours at a relative humidity of 48% to 52% and within a temperature range of 22° C. to 24° C. Ideally, the softness panel testing should take place within the confines of a constant temperature and humidity room. If this is not feasible, all samples, including the controls, should experience identical environmental exposure conditions.

Softness testing is performed as a paired comparison in a form similar to that described in “Manual on Sensory Testing Methods”, ASTM Special Technical Publication 434, published by the American Society For Testing and Materials 1968. Softness is evaluated by subjective testing using what is referred to as a Paired Difference Test. The method employs a standard external to the test material itself. For tactile perceived softness two samples are presented such that the subject cannot see the samples, and the subject is required to choose one of them on the basis of tactile softness. The result of the test is reported in what is referred to as Panel Score Unit (PSU). With respect to softness testing to obtain the softness data reported herein in PSU, a number of softness panel tests are performed. In each test ten practiced softness judges are asked to rate the relative softness of three sets of paired samples. The pairs of samples are judged one pair at a time by each judge: one sample of each pair being designated X and the other Y. Briefly, each X sample is graded against its paired Y sample as follows:

1. a grade of plus one is given if X is judged to may be a little softer than Y, and a grade of minus one is given if Y is judged to may be a little softer than X;

2. a grade of plus two is given if X is judged to surely be a little softer than Y, and a grade of minus two is given if Y is judged to surely be a little softer than X;

3. a grade of plus three is given to X if it is judged to be a lot softer than Y, and a grade of minus three is given if Y is judged to be a lot softer than X; and, lastly:

4. a grade of plus four is given to X if it is judged to be a whole lot softer than Y, and a grade of minus 4 is given if Y is judged to be a whole lot softer than X.

The grades are averaged and the resultant value is in units of PSU. The resulting data are considered the results of one panel test. If more than one sample pair is evaluated then all sample pairs are rank ordered according to their grades by paired statistical analysis. Then, the rank is shifted up or down in value as required to give a zero PSU value to which ever sample is chosen to be the zero-base standard. The other samples then have plus or minus values as determined by their relative grades with respect to the zero base standard. The first tissue product is the zero base standard herein. The number of panel tests performed and averaged is such that about 0.2 PSU represents a significant difference in subjectively perceived softness.

### HFS (Horizontal Full Sheet)

The Horizontal Full Sheet (HFS) test method determines the amount of distilled water absorbed and retained by the paper of the present invention. This method is performed by first weighing a sample of the paper to be tested (referred to herein as the “Dry Weight of the paper”), then thoroughly wetting the paper, draining the wetted paper in a horizontal position and then reweighing (referred to herein as “Wet Weight of the paper”). The absorptive capacity of the paper is then computed as the amount of water retained in units of grams of water absorbed by the paper.

The apparatus for determining the HFS capacity of paper comprises the following: An electronic balance with a sensitivity of at least ±0.01 grams and a minimum capacity of 1200 grams. The balance should be positioned on a balance table and slab to minimize the vibration effects of floor/benchtop weighing. The balance should also have a balance pan to be able to handle the size of the paper tested. The balance pan can be made out of a variety of materials. Plexiglass is a common material used.

A sample support rack and sample support cover is also required. Both the rack and cover are comprised of a lightweight metal frame, strung with 0.012 in. (0.305 cm) diameter monofilament so as to form a grid of 0.5 inch squares (1.27 cm2). The size of the support rack and cover is such that the sample size can be conveniently placed between the two.

The HFS test is performed in an environment maintained at 23±1° C. and 50±2% relative humidity. A water reservoir or tub is filled with distilled water at 23±1° C. to a depth of 3 inches (7.6 cm).

The paper to be tested is carefully weighed on the balance to the nearest 0.01 grams. The dry weight of the sample is reported to the nearest 0.01 grams. The empty sample support rack is placed on the balance with the special balance pan. The balance is then zeroed (tared). The sample is carefully placed on the sample support rack. The support rack cover is placed on top of the support rack. The sample (now sandwiched between the rack and cover) is submerged in the water reservoir. After the sample has been submerged for 60 seconds, the sample support rack and cover are gently raised out of the reservoir.

The sample, support rack and cover are allowed to drain horizontally for 120±5 seconds, taking care not to excessively shake or vibrate the sample. Next, the rack cover is carefully removed and the wet sample and the support rack are weighed on the previously tared balance. The weight is recorded to the nearest 0.01 g. This is the wet weight of the sample.

The grams of water per paper sample absorptive capacity of the sample (or HFS value) is defined as (Wet Weight of the paper—Dry Weight of the paper).

### Tensile Strength Test Method:

One (1) inch by five (5) inch (2.5 cm×12.7 cm) strips of fibrous structure and/or sanitary tissue product are provided. The strip is placed on an electronic tensile tester Model 1122 commercially available from Instron Corp., Canton, Mass. in a conditioned room at a temperature of 73° F.±4° F. (about 28° C.±2.2° C.) and a relative humidity of 50%±10%. The crosshead speed of the tensile tester is 2.0 inches per minute (about 5.1 cm/minute) and the gauge length is 4.0 inches (about 10.2 cm). The Dry Tensile Strength can be measured in any direction by this method. The “Total Dry Tensile Strength” or “TDT” is the special case determined by the arithmetic total of MD and CD tensile strengths of the strips.

All measurements referred to herein are made at 23±/−1° C. and 50% relative humidity, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An array of tissue products comprising:
a. a first group comprising two or more tissue products, from at least two different product manufacturers, each product having an indicium representing an intensive property for softness;
b. a second group comprising two or more tissue products, from at least two different product manufacturers, each product having an indicium representing the intensive property for strength or absorbency; and
c. a third group of tissue products comprising two or more tissue products, from at least two different product manufacturers, each product having a lower price, to the consumer, per package of equivalent roll count than each product of the first group and the second group, of tissue products;
wherein the Softness PSU of each product of the first group is equal to or greater than the Softness PSU of each product of the second group and each product of the third group; and the HFS value of each product of the second group is greater than about 65 g/sheet.

2. The array of claim 1 wherein the Softness PSU of each product of the first group is 0.3 to about 4 PSUs greater than the Softness PSU of each product of the second group and each product of the third group.

3. The array of claim 1 wherein the Softness PSU of each product of the first group is about 0.5 PSU to about 3 PSUs greater than the Softness PSU of each product of the second group and each product of the third group.

4. The array of claim 1 wherein the HFS value of each product of the second group is greater than the HFS value of each product of the first group and the third group.

5. The array of claim 4 wherein the HFS value of each product of the second group is about 10% to about 45% greater than the HFS value of each product of the first group and the third group.

6. The array of claim 1 wherein each product of the second group comprises an HFS value from about 66 g/sheet to about 90 g/sheet.

7. The array of claim 1 wherein the first group and the third group do not have an indicium representing the intensive property for softness.

8. The array of claim 1 wherein the tissue products are paper towel products or toilet tissue products.

9. The array of claim 8 wherein the total dry tensile strength of each product of the second group is about 550 g/in to about 3,000 g/in tensile.

10. The array of claim 9 wherein each products of the second group comprises a total dry tensile strength that is about 5% to about 45% greater than the tensile strength of each of the products of the third group.

11. A method of merchandising tissue products for display or sale in a retail environment comprising:
providing an array of tissue products comprising:
a. a first group comprising two or more tissue products, from at least two different product manufacturers, each product having an indicium representing an intensive property for softness;
b. a second group comprising two or more tissue products, from at least two different product manufacturers, each product having an indicium representing the intensive property for strength or absorbency; and
c. a third group of tissue products comprising two or more tissue products, from at least two different product manufacturers, each product having a lower price, to the consumer, per package of equivalent roll count than each product of the first group and the second group, of tissue products;
wherein the Softness PSU of each product of the first group is equal to or greater than the Softness PSU of each product of the second group and each product of the third group; and
the HFS value of each product of the second group is greater than about 65 g/sheet.
arranging the first group, second group, and third group of tissue products in visual proximity to each other in the retail store.

12. The method of claim 11 wherein the first, second, and third groups are arranged in lone store display.
